(19) United States
(12) Patent Application Publication
(10) Pub. No.: US 2003/0144855 A1
(43) Pub. Date: Jul. 31, 2003

(54) Computer implemented method and system for demand forecast applications

(76) Inventors: Nir Cohen, Magshimim (IL); Amit Ben Zvi, Givat Shmuel (IL); Mervyn Kaplan, Givataim (IL); Meirav Adoram, Ramat Ha'sharon (IL)

Correspondence Address: NATH & ASSOCIATES, 1030 15th STREET, 6TH FLOOR, WASHINGTON, DC, 20005, US

(21) Appl. No.: 10/058,830

(22) Filed: Jan. 30, 2002

(51) Int. Cl. G06F 17/60

(52) U.S. Cl. 705/1

(57) ABSTRACT

Computer implemented method and system for multi-server computing of demand forecast information for a demand forecast tree to shorten run time.

### FIELD OF THE INVENTION

The invention is in the field of computer implemented methods and systems for forecasting applications in general, and demand forecast applications in particular.

### BACKGROUND OF THE INVENTION

One computer implemented approach for computing demand forecast information for a demand forecast application involves defining a so-called “demand forecast tree” capable of being graphically represented by a single top level node (00) with at least two branches directly emanating therefrom, each branch having at least one node, for example, bottom level node (11) (see FIG. 1). The demand forecast information is computed on the basis of historical time series of observations typically associated with bottom level nodes by a forecast engine commercially available, for example, from Demantra Ltd, Israel under the name Demantra™ Demand Planner. One exemplary demand forecast application is the forecast of demand for a consumer item at an outlet as represented by a bottom level node on the basis of historical sales of the consumer item at the outlet.

Since demand forecast information is becomingly increasingly important for enterprises for a myriad of planning and logistic purposes, one important metric of a demand forecast application is its so-called “run time” defined as the interval between the start time of computing demand forecast information and its end time. For many enterprises, the run time of their demand forecast applications is becoming intolerably long due to increasingly complicated demand forecast trees, the number and sophistication of available mathematical models for forecasting purposes, and the like. Therefore, there is a need to shorten run time but without militating against other equally important metrics of a demand forecast application, for example, accuracy, robustness, and the like.

### SUMMARY OF THE INVENTION

In accordance with the present invention, there is provided a computer implemented method for computing demand forecast information for a demand forecast application capable of being graphically represented by a demand forecast tree having a single top level node with at least two branches directly emanating therefrom each having at least one node with a time series of observations associated therewith, the method comprising the steps of:

(a) providing a database of time series of observations;

(b) providing at least two computer servers each independently capable of computing demand forecast information for an entire branch of the demand forecast tree; and

(c) simultaneously computing demand forecast information for at least two branches of the demand forecast tree on two different computer servers of the at least two computer servers.

The present invention is based on the realization that the demand forecast information for the top level node (0,0) of a demand forecast tree is too abstract to be truly meaningful, and therefore a demand forecast tree can be effectively regarded as consisting of a number of sub-trees equal to the number of its branches directly emanating from its top level node (0,0). By virtue of this, the demand forecast information for different branches or sub-trees of the same demand forecast tree can be computed independently from one another, thereby enabling a forecast engine having two or more computer servers to shorten the run time to compute the demand forecast information for an entire demand forecast tree in comparison to that hitherto achievable by a single computer server. The computer servers of a forecast engine may be co-located or interconnected, for example, over an enterprise's Local Area Network (LAN), over its Wide Area Network (WAN), and the like. Thus, in accordance with the present invention, the run time is effectively delimited between the start time of the first computer server of a forecast engine to start computing demand forecast information for a demand forecasting application and the end time of its last computer server to finish computing demand forecast information for the same demand forecasting application. The present invention is particularly beneficial for demand forecast applications represented by wide demand forecast trees having, say, five or more branches since a greater number of computer servers can simultaneously compute the demand forecast information as opposed to narrow demand forecast trees. The present invention can be applied to new computerized demand forecast applications whilst existing computerized demand forecast applications can be readily retrofitted to support the present invention.

Ideally, the two or more computer servers of a forecast engine simultaneously computing demand forecast information for a run of a demand forecast application would all finish computing simultaneously, thereby optimally minimizing run time. However, computer servers available for a run of a demand forecast application inter alia typically have different computing strengths, and are often not wholly dedicated to a run. Moreover, different branches of the same demand forecast tree typically have different numbers of bottom level nodes which largely determines the computing time required to compute demand forecast information. In view of the above, and since the actual computing time for computing demand forecast information for a branch of a demand forecast tree typically involves considerable computing overhead, in the case that the number of branches of a demand forecast tree exceeds the number of computer servers available for computing demand forecast information, rather than being processed separately, the branches of a demand forecast tree are preferably grouped into discrete tasks each containing one or more branches which are then available for allocation to computer servers for processing on a first come first served basis. The number of tasks is generally an integer multiple of the number of computer servers available for computing demand forecast information as specified by a user, and the computing demands of different tasks of a demand forecast application are preferably equalized as much as possible to facilitate minimizing its run time.

### BRIEF DESCRIPTION OF THE DRAWINGS

In order to understand the invention and to see how it can be carried out in practice, a preferred embodiment will now be described, by way of a non-limiting example only, with reference to the accompanying drawings, in which:

FIG. 1 is a graphical representation showing a demand forecast tree of a demand forecast application for computing demand forecast information for five different items;

FIG. 2 is a table showing time series of sales for the bottom level nodes of the demand forecast tree of FIG. 1;

FIG. 3 is a graphical representation showing a computer implemented system for implementing multi-server computing of demand forecast information for a demand forecast application;

FIG. 4 is a flow chart showing the steps for multi-server computing of demand forecast information for a demand forecast application;

FIG. 5 is a table showing the allocation of branches into tasks by a computer manager of the computer implemented system of FIG. 3; and

FIG. 6 is a graphical representation depicting the effective conversion of the demand forecast tree of FIG. 1 into three imaginary demand forecast sub-trees.

### DETAILED DESCRIPTION OF THE DRAWINGS

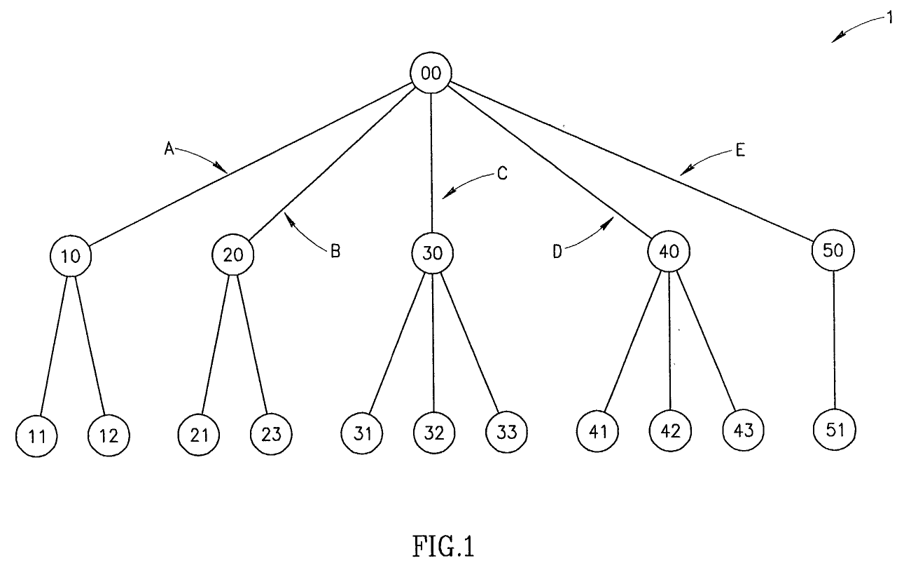

FIG. 1 shows a demand forecast tree 1 having a single top level node (00) with five branches A, B, C, D and E for correspondingly representing the sale of Item 1 (top level-1 node (10)) at Locations 1 and 2 (bottom level nodes (11) and (12)), Item 2 (top level-1 node (20)) at Locations 1 and 3 (bottom level nodes (21) and (23)), Item 3 (top level-1 node (30)) at Locations 1, 2 and 3 (bottom level nodes (31), (32) and (33)), Item 4 (top level-1 node (40)) also at Locations 1, 2 and 3 (bottom level nodes (41), (42) and (43)); and Item 5 (top level-1 node (50)) at Location 1 (bottom level node (51)) only.

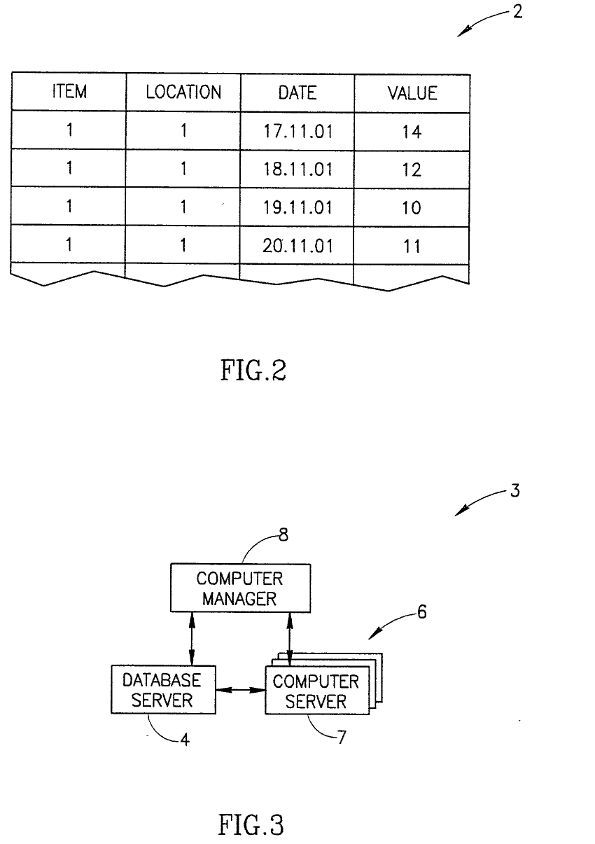

FIG. 2 shows a table 2 containing historical time series of sales for each of the bottom level nodes (11), (12), . . . (43), and (51), the unique key of each sales record being Item ID, Location ID, and Date.

FIG. 3 shows a computer implemented system 3 including a database server 4 for storing time series of sales, a forecast engine 6, for example, commercially available, for example, from Demantra Ltd. Israel under the name Demantra™ Demand Planner, including two or more computer servers 7 each independently capable of computing demand forecast information for an entire branch of the demand forecast tree 1, and a computer manager 8 for allocating branches into tasks.

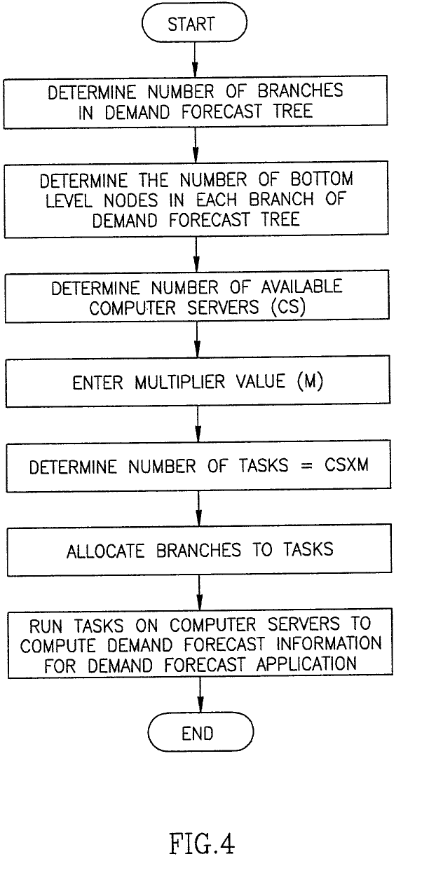

The run of a demand forecast application for computing demand forecast information for the demand forecast tree 1 is now described with reference to FIGS. 4-6:

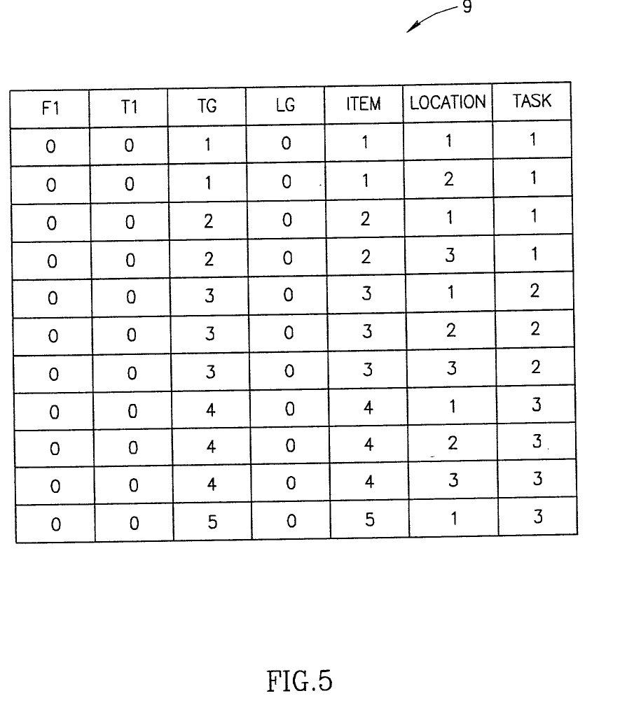

The computer manager 8 determines the number of branches BRANCH in the demand forecast tree 1, the number of bottom level nodes NODES in each of its branches A, B, C, D and E, and the number of computer servers CS available for the run. The computer manager 8 also prompts the user to enter the value MULTIPLIER specifying how many tasks he wants each computer server to process on average. Based on the above information, the computer manager 8 completes a task traverse table 9 (see FIG. 5) similar to a conventional node traverse table (not shown) except that it additionally includes a column for specifying the task number TASK of the task to which each branch A, B, C, D and E has been allocated.

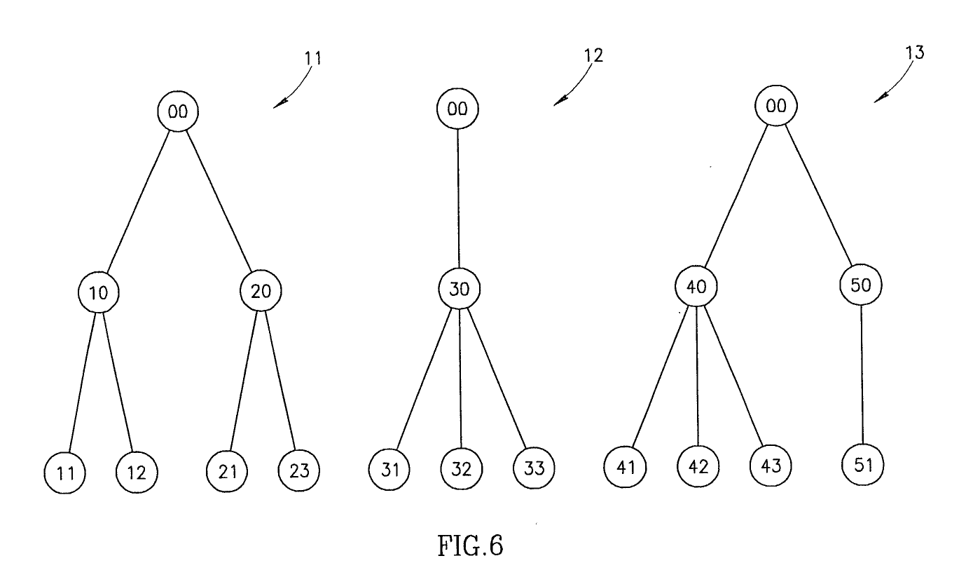

In the event that CS=1, the computer manager 8 would assign all the branches A, B, C, D and E to the singly available computer server 7 would process all the branches in a similar manner to a conventional computer implemented system without the benefit of the present invention. In the event CS>BRANCH, the computer manager 8 would assign the branches A, B, C, D and E to five different tasks such that each branch or task is processed by a dedicated computer server 7. In the event that BRANCH>CS>1, the computer manager 8 typically divides the number of branches into the number of tasks given by the product of the values of CS and MULTIPLIER such that the expected computing time for each task is substantially equal. For example, assuming that CS=3 and MULTIPLIER=1, the computer manager 8 would group the branches A, B, C, D and E into three tasks as follows: Task 1 having branches A and B with a total of four bottom level nodes (11), (12), (21), and (23); Task 2 having branch C only with three bottom level nodes (31), (32) and (33); and Task 3 having branches D and E also with four bottom level nodes (41), (42), (43), and (51). Thus, the demand forecast tree 1 is effectively converted into three separate sub-trees 11, 12, and 13 (see FIG. 6).

The actual traversal of the branches of each task typically takes place in the same manner as in a conventional traversal of a demand forecast tree, namely, from left to right at the top level-1 nodes level, and from leftmost bottom level node to rightmost bottom level node at the bottom level nodes level within each branch. Also, as in the case of a single computer server traversal of a demand forecast tree, the demand forecast information at a top level-1 node is either the sum of the demand forecasts of all of its one or more bottom level nodes on the condition that a demand forecast can be computed for each of its one or more bottom level nodes or it is estimated in the case that a demand forecast cannot be computed for one or more of its bottom level nodes.

While the invention has been described with respect to a limited number of embodiments, it will be appreciated that many variations, modifications, and other applications of the invention can be made within the scope of the appended claims.

1. Computer implemented method for computing demand forecast information for a demand forecast application capable of being graphically represented by a demand forecast tree having a single top level node with at least two branches directly emanating therefrom each having at least one node with a time series of observations associated therewith, the method comprising the steps of:
(a) providing a database for storing time series of observations;
(b) providing at least two computer servers each independently capable of computing demand forecast information for an entire branch of the demand forecast tree; and
(c) simultaneously computing demand forecast information for at least two branches of the demand forecast tree on two different computer servers of the at least two computer servers.

2. The method according to claim 1 and further comprising the steps of:
(d) allocating each and every branch of the demand forecast tree to a task including one or more branches for execution on a single computer server of the at least two computer servers where the same computer server computes the demand forecast information for an entire task.

3. The method according to claim 2 and further comprising the steps of
(e) determining the number of tasks as the product of the number of computer servers available for computing demand forecast information and a user entered value.

4. The method according to claim 2 wherein the total number of bottom level nodes of the branches of each task is substantially equal for all the tasks.

5. Computer implemented system for computing demand forecast information for a demand forecast application capable of being graphically represented by a demand forecast tree having a single top level node with at least two branches directly emanating therefrom each having at least one node with a time series of observations associated therewith, the system comprising:
(a) a database server for storing time series of observations; and
(b) a forecast engine including two or more computer servers each independently capable of computing demand forecast information for an entire branch of the demand forecast tree for simultaneously computing demand forecast information for at least two branches of the demand forecast tree on two different computer servers of the at least two computer servers.

6. The system according to claim 5 and further comprising a computer manager for allocating each and every branch allocating to a task including one or more branches for execution on a single computer server of the at least two computer servers where the same computer server computes the demand forecast information for an entire task.

7. The system according to claim 6 wherein the computer manager determines the number of tasks as the product of the number of computer servers available for computing demand forecast information and a user entered value.

8. The system according to claim 7 wherein the total number of bottom level nodes of the branches of each task is substantially equal for all the tasks.
